(19) United States
(12) Patent Application Publication
(10) Pub. No.: US 2020/0341747 A1
(43) Pub. Date: Oct. 29, 2020

(54) METHODS FOR NODE QUALITY CONTROL IN LARGE SCALE DISTRIBUTED SYSTEMS

(71) Applicant: DriveAds Inc., Dallas, TX (US)

(72) Inventors: Michael Brady, Dallas, TX (US); Ed Brady, Burlington, VT (US); Andrew Deweever, Denver, CO (US)

(21) Appl. No.: 16/855,224

(22) Filed: Apr. 22, 2020

Related U.S. Application Data
(63) Continuation of application No. 62/837,722, filed on Apr. 23, 2019.

(51) Int. Cl. G06F 8/65; G06F 8/71; H04W 72/12; H04W 4/029

(52) U.S. Cl. CPC G06F 8/65; H04W 4/029; H04W 72/1263; G06F 8/71

(57) ABSTRACT

Methods for verifying and updating node software for a plurality of wireless nodes for a mobile fleet are disclosed. The methods provide for batch verification and updating of node software using a randomized standoff period for each wireless node without individual check-in assignment by the server.

### RELATED APPLICATION

The present application is a continuation of provisional application Ser. No. 62/837,722 filed Apr. 23, 2019 which is incorporated herein by reference in its entirety.

### BACKGROUND

The present invention relates to communications technologies, and in particular, to a method for quality control of wireless nodes in large scale distributed systems. More specifically, the invention relates to managing verification and updates in systems where the wireless nodes are in excess of 10,000.

Updating a wireless node can be performed wirelessly over the air or via a physical connection when available. The Open Mobile Alliance (OMA) has developed techniques for device management (DM) including techniques for updating. A typical update may require dozens, hundreds, thousands of files, or more. Because of the significant amount of data required to update large scale nodes, minimizing concurrent network bandwidth usage remains important.

Some solutions wrap all necessary update files into a single file to be downloaded by a particular node. However, the various firmware/hardware permutations of a group of deployed nodes can be of high number and of highly variability. This can result in unique update files being required for each unique permutation. Such update files are known to be generated ahead of time or generated on the fly, as needed. Both of these methods can be inefficient, wasteful, and costly, particularly if only a subset of the permutations is actually in use. Generating a large number of unique update files ahead of time can consume a large amount of storage space. Generating unique update files on the fly can result in network bottlenecks when mobile device updates are performed over a short period of time as computing power and network resources to handle such network traffic peaks may not be available.

Various schemes have been used to update large groups of nodes that require replacement software. In these schemes, a software update package instructing the nodes how to update their software is typically distributed from a software update server over a network to the nodes and installed immediately upon receipt. The timing of distribution of the software update package is generally determined by an update management application executing on the software update server.

A significant technical challenge that arises in updating the software of a large group of nodes is how to avoid resource oversubscription. When a software update server attempts to distribute a software update package to a large number of nodes around the same time, the network may become congested. When this happens, the distribution process is slowed and other applications competing for network bandwidth may be starved. Moreover, the processing resources of the software update server may become oversubscribed, further delaying the distribution. In extreme cases, the network or the software update server may even crash.

In addition to starving other applications and risking network or server outages, attempts to distribute a software update package to a large group of nodes around the same time can render meaningless a software update installation time chosen by a network administrator. Network administrators often want software updates to be installed on nodes during “off hours” when the usage level of the nodes is minimal, and therefore start distribution of the software update package during these “off hours”. However, if delivery of the software update package is substantially delayed due to resource oversubscription, actual installation may creep into hours of peak usage.

In an attempt to avoid resource oversubscription problems, some update management applications allow network administrators to stagger distribution of software updates to a node group. In these applications, software update packages are distributed and installed over “threads” and a network administrator selects how many threads run in parallel. When installation is completed on the first parallel group of threads, the management application starts distribution on the next parallel group of threads, and so on. However, the burden to choose an optimum number of threads to run in parallel is on the network administrator. If the network administrator chooses a number that is too large, the update process may be plagued by resource oversubscription problems. If the network administrator chooses a number that is too small, the update process may take too long and installation may extend into hours of peak node usage.

Thus, known techniques for updating mobile device firmware suffer from a number of disadvantages, including inefficient use of storage space, high network demands, and costly implementation.

Furthermore, when a system relies on a large number of wireless nodes to continuously provide collected data, any interruptions to the wireless nodes, including the time necessary to verify the software and/or hardware version of the wireless nodes, significantly impacts the overall data collected by the system.

For example, in a large scale distributed system where each wireless node resides on a one of a large fleet of vehicles, an update to all of the wireless nodes would in effect shut down all data gathering by each wireless node, even to portions of the fleet which are in motion and is required to gather data.

Although individual wireless nodes in a large scale distributed system may continue to operate with differing software and/or hardware versions, it is preferable for the wireless nodes to achieve software and hardware homeostasis to avoid conflicts and issues of varied effectiveness of data collection.

As such, there exists a need to manage verification and updates in large scale distributed system while minimizing impact to data collection from wireless nodes operating on a mobile fleet. In addition, to avoid congestion during updates in a large scale distributed system, staggering updates of node without the instructions from the server is needed.

For example, a popular sever used for single applications is a Bastion server which provide several benefits and features. Such benefits and features include logging of clients, protecting against port scanning, defending zero-day exploits, and preventing rouge SSH access by providing an additional layer to slow down attacks.

However, these benefits are intended for standard type of access such as fetch calls (e.g. DNS, FTP, HTTPS, etc.). In a large scale node network where tens of thousands of devices are potentially connecting to the Bastion server to perform various functions such as such as determining its campaign, general access, retrieving updates and downloads, etc, the Bastion server will likely be overwhelmed.

These and other advantages of the present invention will be clarified in the description of the preferred embodiments taken together with the figures.

### SUMMARY OF THE INVENTION

A method for verifying and updating a plurality of wireless nodes for a mobile fleet is disclosed. The method provides for batch verification and updating by using a randomized standoff period implemented for each wireless node thereby staggering check-in events of each wireless node to the server without the need for intervention by the server. Furthermore, batches of wireless nodes may be determined at random or based on factors such as the current operation of the fleet.

In one aspect, a first node contains a first random standoff value and a second node contains a second random standoff value. When a server communicates an instruction indicating a request to update node software to a plurality of wireless nodes, the server receives a connection to update node software from a first wireless node at a first time period, wherein the first time period is based at least in part on the instruction and the first random standoff value. The server also receives a connection to update node software from a second wireless node at a second time period, wherein the second time period is based at least in part on the instruction and the second random standoff value

### BRIEF DESCRIPTION OF THE DRAWINGS

FIG. 1 is a pictorial representation of the large scale distributed system in accordance with the present invention.

FIG. 2 is a flow diagram showing a method for wireless node qualify control in a large scale distributed system in accordance with the present invention.

FIG. 3 is a JSON Batch File structure administrator for nodes which have reported the least activity in the past 72 hours operable with an exemplary embodiment of the present invention.

FIG. 4 is a JSON Batch File structure wherein the nodes which correspond to a specific metropolitan area operable with an exemplary embodiment of the present invention.

### DETAILED DESCRIPTION

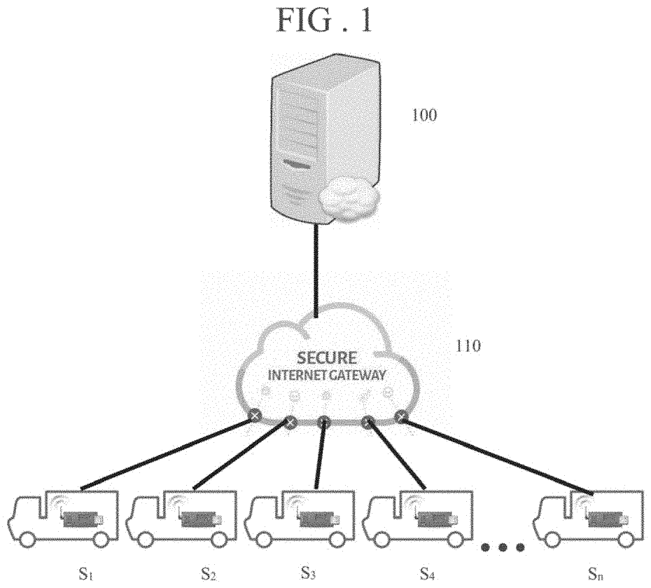

While the inventions disclosed herein are susceptible to various modifications and alternative forms, specific embodiments are shown by way of examples in the drawings and described in detail. It should be understood that the figures and detailed description discussed herein are not intended to limit the invention to the particular forms disclosed. On the contrary, the intention is to cover all modifications, equivalents and alternatives falling within the spirit and scope of the present inventions as defined by the appended claims. Description will now be given of the invention with reference to FIGS. 1-4.

As shown generally in FIG. 1, the novel method operates in a large scale distributed system. In an exemplary embodiment, server 100 is preferably a bastion host which generally hosts a single application, in this case a basic check-in and update system. Additionally, as the server 100 is limited in application it is designed and configured to withstand outside attacks.

In the exemplary embodiment, server 100 is accessible via a secure remote management system 110. Sever 100 is also in communications with wireless nodes S1, S2, S3, S4 . . . Sn. The wireless nodes S1, S2, S3, S4 . . . Sn are preferably mounted on moving vehicles for collection of data. As such, wireless nodes typically communicate via potentially slower and unreliable network connections such as cellular networks which may be prone to additional connectivity issues due to movement of the vehicles to which the wireless nodes are attached to.

In an exemplary embodiment, a wireless node may include a single-board computer, such as a Raspberry Pi, configured to establish a “standoff” period, retrieve any updated software versions from a server and install the updated version on the single-board computer. In the exemplary embodiment, the single-board computer further includes a real-time hardware clock with battery backup.

Server 100 stores data structures such as a Javascript Object Notation (“JSON”) file for use as a part of a check-in system configured to allow check-ins by the wireless nodes. To minimize data use, the JSON file is preferably lightweight and text based. However, any type of simple data structure may be used in accordance with the present invention. Using the secure remote management system 110, any wireless node S1 . . . Sn may access the JSON file. The secure remote management system may permit a two way SSH connection between each wireless node and server 100.

In the exemplary embodiment, the JSON file may comprise of two data elements such as nodes and version.node. Nodes may refer to the MAC address, nickname, number, or any other known identification for a wireless node. Version.node refers to the software version that the specific wireless node should be operating. This JSON file may include the listing for only a subset of S1-Sn or may include all S1-Sn nodes, depending on batching selections by the administrator. Version.node will typically identify the version number of the most up to date repository version, although prior versions may be listed for purposes of rolling back updates on a wireless node. Server 100 will preferably include a compressed copy of the software update repository which would be accessible via the same secure remote management system 110 as the JSON file.

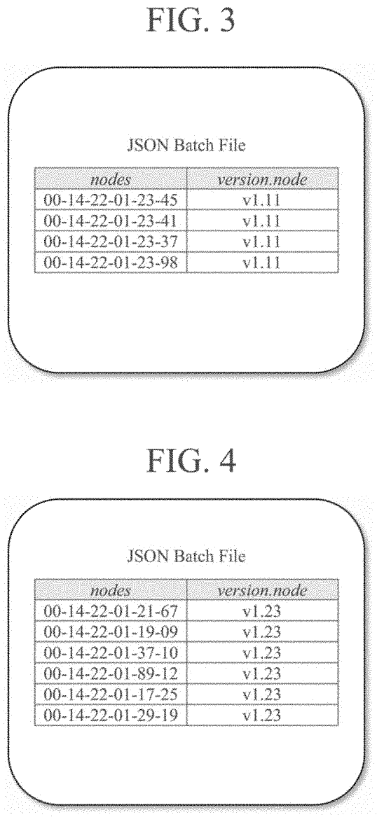

Turning to FIG. 3 and FIG. 4, illustrated are sample JSON files which allows for arbitrary batches on any given deployment for updates. For example, in FIG. 3, the administrator selects the wireless nodes which have reported the least activity in the past 72 hours for updating. The MAC addresses for 4 wireless nodes fitting this description is automatically generated into the JSON file along with the most up to date wireless node software version. For example, in FIG. 4, to implement a new feature in a test city, the administrator selects the wireless nodes for a specific metropolitan area and identifies the latest version resident on the server. However, because of the flexibility of the present invention, any form batch selection may be conducted in accordance with the spirit of the invention.

In another example, wherein a select number of wireless nodes are reporting operation errors, a batch update for the wireless nodes reporting operation errors may be implemented by the same JSON file. Because of this flexibility, the server 100 is not required to push out updates to individual wireless nodes as wireless nodes will self-identify the need to update its software versions.

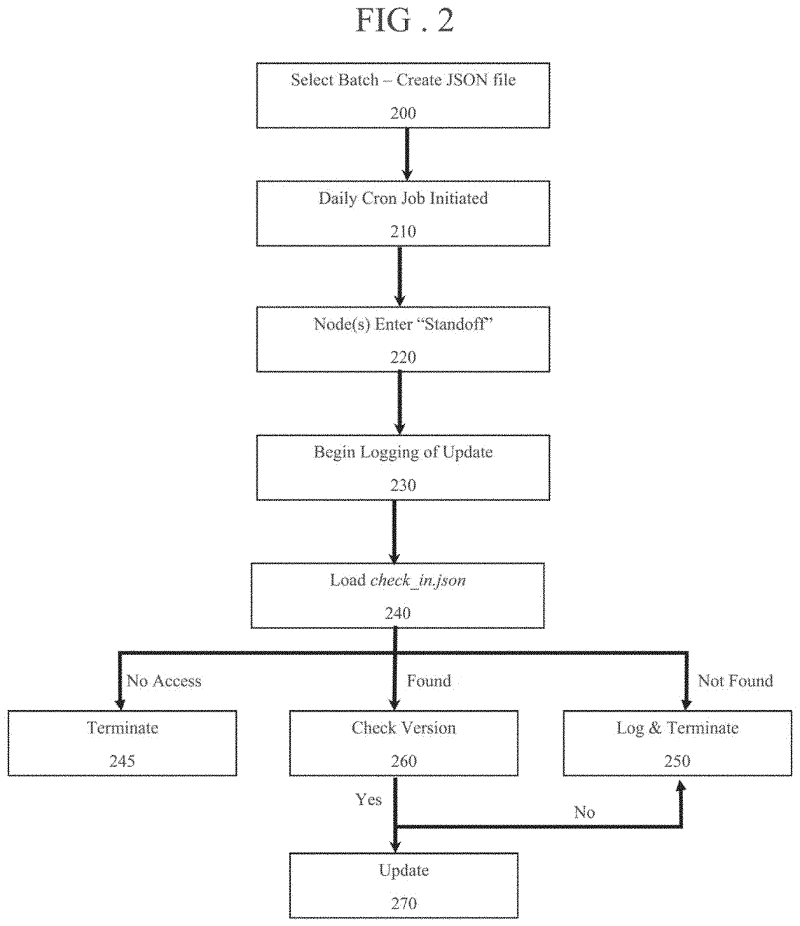

Turning to FIG. 2, a flow chart describing an exemplary the novel method is described. Although this novel method is described based on operation at the wireless node, a similar novel method may be implemented at the server 100 without deviating from the spirit of the invention.

First, in step 200, server 100 selects a batch of wireless nodes from S1 . . . Sn. Batches may be selected based on various factors such as minimal fleet impact, wireless nodes with reported errors, specific metropolitan area, etc. For example, a batch may be selected from wireless nodes on vehicles currently not in motion and gathering data. As part of step 200, the server creates a list of wireless nodes (nodes) and the software version to be updated to for each such wireless node (version.node).

An exemplary wireless node of the present invention preferably utilizes a time-based job scheduler such as the cron software utility to maintain daily verification and updates of the wireless node. In step 210, the daily cron job is initiated on a wireless node. Although a wireless node may be always on to track system time, preferably each wireless node includes a real-time hardware clock with a battery back.

Once initiated, the wireless node enters into a “standoff” mode 220. In the standoff mode, the wireless node sleeps for a random period of time within a predetermined range. For example, a randomizer may be used to select a sleep time between 1-60 minutes. This standoff mode with a random period serves to stagger the various times when wireless nodes S1 . . . Sn checks in on the daily basis. As every wireless node checks in daily, this staggering serves to avoid sever overload and bandwidth congestion. Additionally, as some wireless nodes may be located in areas where wireless communication signals are inoperable at certain times of day, the random standoff decreases the likelihood that the wireless node will fail at check in attempts over a sustained period.

After the “standoff” period, wireless node 230 records into a log details related to the check-in event. At step 240, wireless node attempts to access the check_in.json file from server 100. If the wireless node fails for any reason to access the check_in.json file, it will terminate and log the event 245 as an unsuccessful check in. This log entry will note that either the wireless node could not resolve a connection or it could not access the JSON file despite a connection. If the wireless node successfully access the check_in.json file but is unable to locate its existence in the JSON file indicating that an update is not required, the wireless node will log the event and terminate 250. This log will note that the check in was successful but not update was performed.

In a preferred embodiment, step 250 is the predominant result for most wireless nodes as updates are not necessary on a daily basis for each wireless node. However, when a batch update is set by an administrator, the wireless node then identifies that its ID is found in the check_in.json file under nodes. Concurrently, the wireless node compares its current software version to the version identified in version.node 260 in the check_in.json file. If the wireless node's current version matches the current version.node, then the wireless node terminates the check in and generates a log entry that show the check in was successful and that the wireless node already operates the specified version.

However, in the case where the wireless node identifies itself in nodes in the check_in.json file and the version.node does not match the current operating software version in the corresponding wireless node, the wireless node performs an update to the version identified in version.node 270 and logs the event.

To perform the update, the wireless node downloads and extracts the software version in the repository. Once extracted, an installer script present on the wireless node executed to apply the downloaded update. In addition to those updates, a docker compose tool will be executed for all docker services on the wireless node. At anytime during this update process, if an error occurs, the wireless node will generate a log entry indicating the error and terminating the update script.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

What is claimed is:

1. A server-based method for updating node software of wireless nodes in a mobile network;
assigning a plurality of random standoff values to a plurality of wireless nodes;
communicating an instruction indicating a request to update node software to a subset of the plurality of wireless nodes;
receiving from a first wireless node of the subset of the plurality of wireless nodes, a first connection to update node software of the first wireless node at a first time period, wherein the first time period is based at least in part on the instruction and a first random standoff value assigned to the first wireless node; and
receiving from a second wireless node of the subset of the plurality of wireless nodes, a second connection to update node software of the second wireless node, wherein the second time period is based at least in part on the instruction and a second random standoff value assigned to the second wireless node.

2. The method of claim 1, wherein the subset of the plurality of wireless nodes are selected from wireless nodes reporting operation errors.

3. The method of claim 1, wherein the subset of the plurality of wireless nodes are selected from wireless nodes assigned to a geographic area.

4. The method of claim 1, wherein the subset of the plurality of wireless nodes are selected from wireless nodes not currently in motion.

5. The method of claim 1, wherein the subset of the plurality of wireless nodes comprises the entirety of the plurality of wireless nodes.

6. The method of claim 1, further comprising, comparing wherein communicating an instruction indicating a request to update node software to a subset of the plurality of wireless nodes further comprises communicating an instruction of a daily update time.

7. The method of claim 1, further comprising: comparing node software of the first wireless node to node software stored on a server.

8. The method of claim 7, further comprising: transmitting the node software stored on the server to the first wireless node.

9. A server-based method for updating node software of wireless nodes in a mobile network;
communicating an instruction indicating a request to update node software to a plurality of wireless nodes;
receiving from a first wireless node of the subset of the plurality of wireless nodes, a first connection to update node software of the first wireless node at a first time period, wherein the first time period is based at least in part on the instruction and a first random standoff value assigned to the first wireless node; and
receiving from a second wireless node of the subset of the plurality of wireless nodes, a second connection to update node software of the second wireless node, wherein the second time period is based at least in part on the instruction and a second random standoff value assigned to the second wireless node.

10. The method of claim 9, further comprising, comparing wherein communicating an instruction indicating a request to update node software to a subset of the plurality of wireless nodes further comprises communicating an instruction of a daily update time.

11. The method of claim 9, further comprising: comparing node software of the first wireless node to node software stored on a server.

12. The method of claim 11, further comprising: transmitting the node software stored on the server to the first wireless node.

13. A method of updating node software of a wireless node within a plurality of wireless nodes operable with a server, comprising:
storing in memory, a standoff value;
receiving, from a server, an instruction indicating a request to update node software;
initiating a connection to the server, after a time period based at least in on the instruction and the standoff value stored in memory; and
accessing node software stored on the server upon the connection to the server.

14. The method of claim 13 where in the standoff value is generated by a randomizer.

15. The method of claim 13, further comprising: comparing node software of the wireless node to node software stored on the server.

16. The method of claim 14, further comprising: downloading the node software stored on the server to the first wireless node.
